(19) United States
(12) Patent Application Publication
(10) Pub. No.: US 2017/0277508 A1
(43) Pub. Date: Sep. 28, 2017

(54) Wearable Wireless Controller

(71) Applicant: Nicholas Carthen, Kingwood, TX (US)

(72) Inventor: Nicholas Carthen, Kingwood, TX (US)

(21) Appl. No.: 15/360,043

(22) Filed: Nov. 23, 2016

Related U.S. Application Data
(60) Provisional application No. 62/312,697, filed on Mar. 24, 2016.

(51) Int. Cl. G06F 3/16; G06F 3/01

(52) U.S. Cl. CPC G06F 3/165; G06F 3/014

(57) ABSTRACT

A wearable wireless controller for operating the playback settings of an audio playing device. The wearable wireless controller includes a tapered sleeve that can receive a finger of a user, wherein the sleeve includes one or more controls thereon. The controls can be conveniently operated by the thumb on the same hand in which the sleeve is worn. The controller includes a wireless transmitter that can wirelessly connect to an audio playing device. The controls on the sleeve can operate the playback settings of the coupled audio playing device.

### CROSS REFERENCE TO RELATED APPLICATION

This application claims the benefit of U.S. Provisional Application No. 62/312,697 filed on Mar. 24, 2016. The above identified patent application is herein incorporated by reference in its entirety to provide continuity of disclosure.

### BACKGROUND OF THE INVENTION

The present invention relates to wearable wireless controllers. More specifically, the present invention provides a sleeve configured to be worn on a finger, wherein the sleeve includes controls wirelessly connected to an audio playing device and adapted to be controlled via the touch of another finger on the same hand on which the sleeve is attached.

While jogging, running, or performing other exercises, a majority of people enjoy listening to music. A smartphone, MP3 player, or other electronic device can be stored in a pocket or in an armband pocket wrapped around the upper portion of the arm. However, it is difficult to change a song, adjust the volume, or stop and start the music while exercising. Additionally, the placement of an audio playing device in a pocket or an armband pocket is not easily viewed by a person unless the audio playing device is removed therefrom

Consequently, an individual must stop what they are doing in order to adjust their music device, causing loss of focus.

Further, storing an audio playing device in an armband or other carrier requires an individual to be tethered to the carrier by an earphone wire. The wire obstructs an individual's performance by limiting the individual's range of motion and can cause an individual to become tangled, especially when attempting to change the music settings. Therefore, there exists a need for a device that can control playback settings of a wireless coupled electronic device.

Devices have been disclosed that relate to wearable wireless controllers. These include devices that have been patented and published in patent application publications. Some of these devices generally relate to a piece of jewelry or glove configured to control a mobile telephone. However, these devices fail to provide a sleeve adapted to attach over a finger and control an audio playing device. Other devices generally relate to headbands that are adapted to control a music player. However, these devices fail to provide a sleeve configured to fit on a user's finger in order to wirelessly control an audio playing device.

In light of the devices disclosed in the prior art, it is submitted that the present invention substantially diverges in design elements from the prior art and consequently it is clear that there is a need in the art for an improvement to existing wearable wireless controllers. In this regard the instant invention substantially fulfills these needs.

### SUMMARY OF THE INVENTION

In view of the foregoing disadvantages inherent in the known types of wearable wireless controllers now present in the prior art, the present invention provides a new wearable wireless controller wherein the same can be utilized for providing convenience for the user when wirelessly controlling an audio playing device while jogging, running, or performing other exercises.

It is therefore an object of the present invention to provide a new and improved wearable wireless controller that has all of the advantages of the prior art and none of the disadvantages. The wearable wireless controller comprises a tapered sleeve configured to fit over a finger of a user, wherein the sleeve includes one or more controls thereon. The controls on the sleeve can be conveniently operated by the thumb on the same hand in which the sleeve is worn. The controller includes a wireless transmitter that can wirelessly connect to an audio playing device. The controls on the sleeve can operate the playback settings of the coupled audio playing device.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the wearable wireless controller.

FIG. 2A shows a perspective view of a rear side of an embodiment of the wearable wireless controller.

FIG. 2B shows a perspective view of an alternate embodiment of the wearable wireless controller.

FIG. 3 shows a diagram of a control circuit of the wearable wireless controller.

FIG. 4 shows a perspective view of the wearable wireless controller in use.

### DETAILED DESCRIPTION OF THE INVENTION

Reference is made herein to the attached drawings. Like reference numerals are used throughout the drawings to depict like or similar elements of the wearable wireless controller. For the purposes of presenting a brief and clear description of the present invention, the preferred embodiment will be discussed as used for wirelessly controlling an audio playing device while jogging, running, or performing other exercises. The figures are intended for representative purposes only and should not be considered to be limiting in any respect.

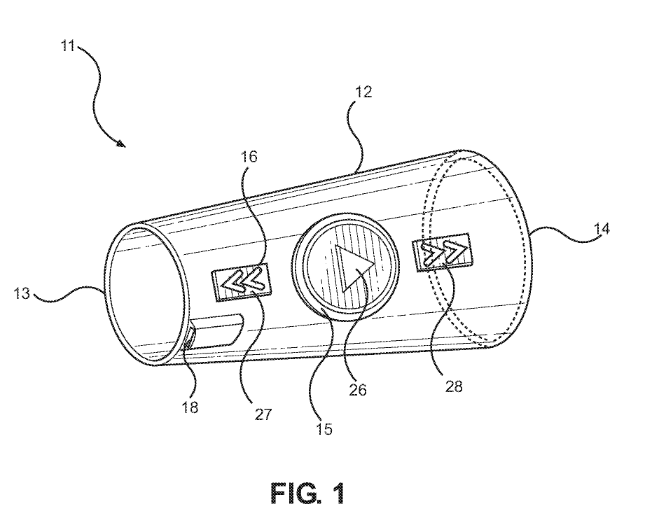

Referring now to FIG. 1, there is shown a perspective view of an embodiment of the wearable wireless controller. The wearable wireless controller 11 comprises a sleeve 12 having an open first end 13 and an open second end 14. The sleeve 12 is configured to receive a finger of a user. In the illustrated embodiment, the second end 14 of the sleeve 12 is open so that the sleeve 12 can be worn on the user's finger such that the finger extends out from the sleeve 12. However, in an alternate embodiment, the second end 14 is closed so that the user's finger does not extend outward from the sleeve 12 and is instead enclosed thereby. The first end 13 of the sleeve 12 is configured to be worn between the distal phalanx and middle phalanx of a finger, such as the index finger. The second end 14 of the sleeve 12 is configured to be worn between the middle phalanx and proximal phalanx of the same finger on which the first end 13 is positioned. In the illustrated embodiment, the sleeve 12 is tapered towards the first end 13 thereof in order to allow the sleeve to fit flush on a finger having a larger girth on the proximal end thereof. In other embodiments, the sleeve 12 is cylindrical in shape.

The sleeve 12 comprises one or more controls 16 disposed on the exterior surface 22 thereof. In the illustrated embodiment, the controls 16 are configured to wirelessly connect to and remotely operate an audio playing device, such as an MP3 player or smartphone. The wearable wireless controller 11 comprises any suitable controls 16, such as depressible buttons and dials. In the illustrated embodiment, the controls 16 comprise a play/pause button 26, a skip forward button 28, a skip backwards button 27, and a volume dial 15 that can be rotated in opposing directions in order to adjust a volume. The volume dial 15 provided can be rotated clockwise to increase the volume of the audio being played and can be rotated counterclockwise to decrease the volume. Preferably, the volume dial 15 is positioned around the perimeter of the play/pause button 26 so as to conserve space on the sleeve 12.

In alternate embodiments, additional controls are included on the sleeve 12 such as stop, shuffle, among other commonly known audio playback functions. Further, in some embodiments, the sleeve comprises a sensor that detects specific movement, such as a shake of the finger, in order to execute a command, such as shuffling the order of an audio playlist. A charging port 18 is provided, wherein the user can affix a charging device to the charging port 18 so as to charge a power source, such as a rechargeable battery stored within the sleeve 12.

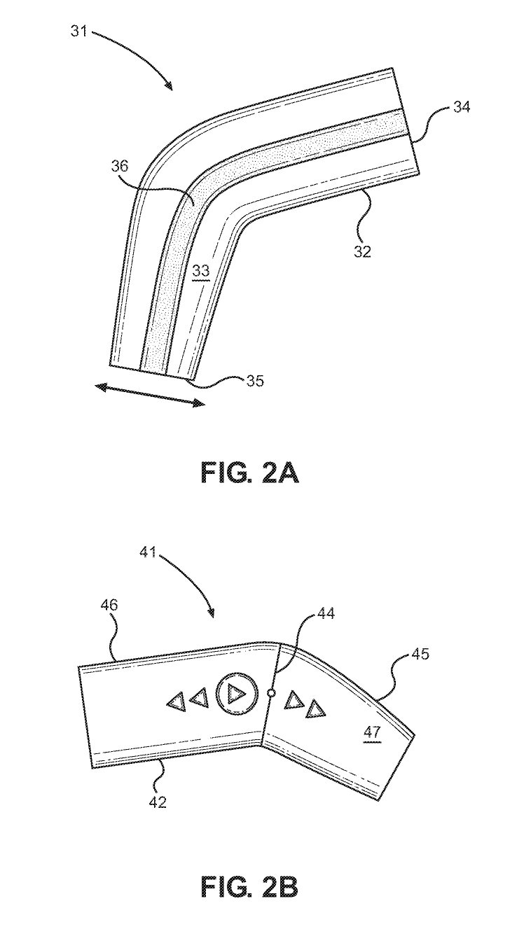

Referring now to FIG. 2A, there is shown a perspective view of a rear side of an embodiment of the wearable wireless controller. In some embodiments, the sleeve 32 is composed of a stretchable material, such as neoprene. In the illustrated embodiment, the rear side 33 of the sleeve 32 of the wearable wireless controller 31 comprises a band 36 extending from the first end 34 of the sleeve 32 to the second end 35 thereof. The rear side 33 of the sleeve 32 is the opposing side on which the controls are located. However, in alternate embodiments, the band 36 can be disposed on the sleeve 32 in any suitable position, such as the lateral side of thereof. The band 36 is composed of a stretchable material in order to allow the sleeve 32 to fit over different sized fingers. In this way, the material of the sleeve 32 surrounding the band 36 can be composed of a less elastic material in order to provide additional support to the controls disposed on the sleeve 32. The band 36 can be connected to the sleeve 32 by any suitable fastener, such as stitching.

Referring now to FIG. 2B, there is shown a perspective view of an alternate embodiment of the wearable wireless controller. In the illustrated embodiment, the first end 45 of the sleeve 42 is pivotally connected to the second end 46 of the sleeve 42 by a hinge 44. The sleeve 42 is tapered towards the first end 45 thereof. The first end 45 of the sleeve 42 is configured to be worn between the distal phalanx and middle phalanx of a finger, such as the index finger. The second end 46 of the sleeve 42 is configured to be worn between the middle phalanx and proximal phalanx of the same finger on which the first end 45 is positioned. The hinge 44 of the sleeve 42 is configured to align with the proximal interphalangeal joint of a finger in order to allow the first end 45 of the sleeve 42 to pivot relative to the second end 46 of the sleeve 42. The hinge 44 is located in any suitable position of the sleeve 42 that does not obstruct the position of the controls.

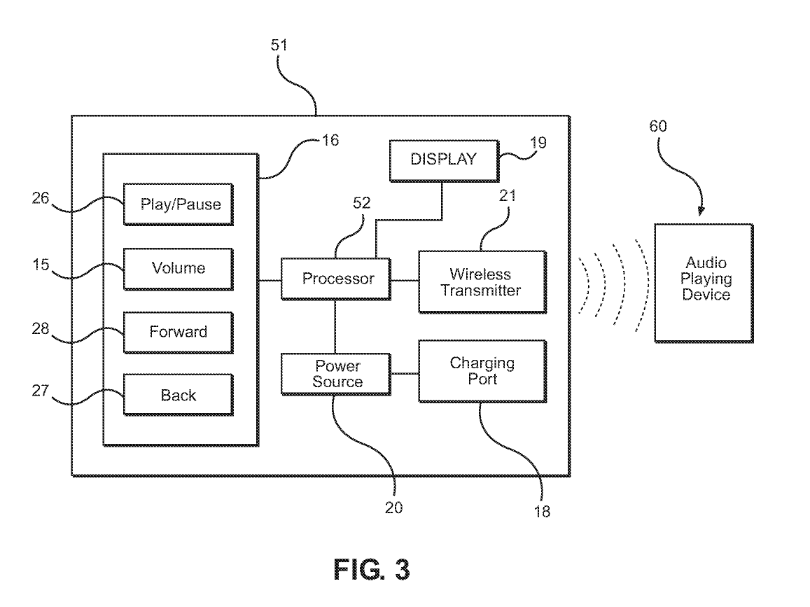

Referring now to FIG. 3, there is shown a diagram of a control circuit of the wearable wireless controller. In the illustrated embodiment, the wearable wireless controller comprises a control circuit 51 having one or more controls 16, a wireless transmitter 21, and a power source 20, such as one or more rechargeable batteries. The power source 20 can be recharged via a charging port 18 that is in electrical communication therewith.

The wireless transmitter 21 is adapted to transmit commands to an external audio playing device 60, such as an MP3 player or a smartphone, wherein the signals control the operation and playback of the audio playing device 60. A processor 52 is provided so as to cause the wireless transmitter 21 to transmit a specific signal to the audio playing device 60 upon actuation of one of the controls 16. In the illustrated embodiment, the controls 16 include a play/pause button 26, a volume dial 15, a forward button 28, and a back button 27. In alternate embodiments, fewer or additional controls 16 may be provided to allow the user to adjust the playback or settings of the external audio playing device 60. Each control 16 is adapted to cause the transmission of a specific signal so that the external audio device 60 will respond in the appropriate manner, when the external audio device 60 has been paired to the remote control device so as to allow for wireless communication therebetween. Any suitable wireless transmitter can be used, such as a Bluetooth module.

In some embodiments, the wearable wireless controller 11 further comprises a display 19 operably connected to the processor 52 and a wireless transceiver in order to receive information from the audio playing device and display that information, such as a song title. The display 19 is an elongated screen, such as an LCD screen, wherein the lateral ends thereof extend between the first and second ends of the sleeve. The display 19 is located in any suitable position of the sleeve, such as above or below the controls 16.

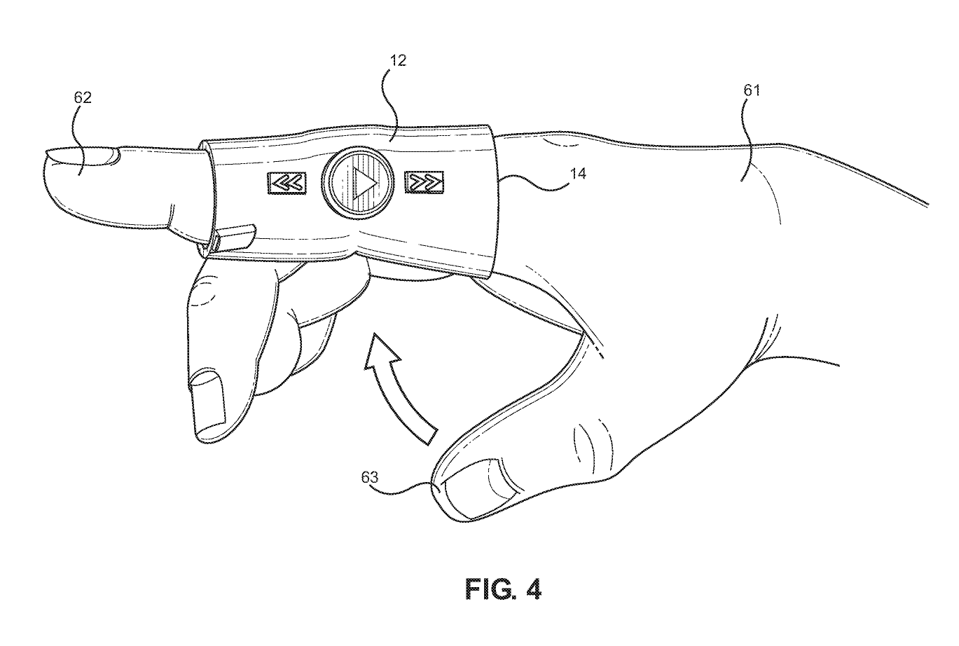

Referring now to FIG. 4, there is shown a perspective view of an embodiment of the wearable wireless controller in use. In operation, the sleeve 12 of the wearable wireless controller is configured to receive a finger, such as the index finger, middle finger, ring finger, or pinky finger. The front side of the sleeve 12 in which the controls are located, is positioned against the lateral side 62 of the finger—the lateral side 62 that is closest to the thumb 63. In this way, the controls on the sleeve 12 can be accessed and operated by the thumb 63 on the same hand 61 in which the sleeve 12 is worn.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. claim:

1) A wearable wireless controller, comprising:
a sleeve having an open first end and an open second end, wherein the sleeve is tapered towards the first end and configured to be worn on a finger of a hand;
one or more controls disposed on an exterior of the sleeve, wherein the one or more controls are configured to control an audio playing device via one or more commands;
a wireless transmitter operably connected to the one or more controls, wherein the wireless transmitter is configured to wirelessly communicate the one or more commands to the audio playing device.

2) The wearable wireless controller of claim 1, wherein the sleeve further comprises a charging port for receiving a charging cord.

3) The wearable wireless controller of claim 1, further comprising a power source disposed on the sleeve, the power source operably connected to the one or more controls and the wireless transmitter.

4) The wearable wireless controller of claim 1, wherein the sleeve is composed of a flexible material.

5) The wearable wireless controller of claim 1, wherein the one or more controls are configured to be operated by a thumb on the hand.

6) The wearable wireless controller of claim 1, further comprising a band extending from the first end of the sleeve to the second end thereof, wherein the band is configured to permit bending of the finger on which it is disposed.

7) The wearable wireless controller of claim 1, wherein the first end is pivotally connected to the second end via a hinge.

8) The wearable wireless controller of claim 1, wherein the one or more controls includes a dial configured to rotate so as to adjust a volume.

9) The wearable wireless controller of claim 1, wherein the wireless transmitter is a Bluetooth transmitter.

10) A wearable wireless controller, comprising:
a sleeve having a first end and an open second end, wherein the sleeve is configured to be worn on a finger of a hand;
one or more controls disposed on an exterior of the sleeve, wherein the one or more controls are configured to control an audio playing device via one or more commands;
a wireless transmitter operably connected to the one or more controls, wherein the wireless transmitter is configured to wirelessly communicate the one or more commands to the audio playing device.

11) The wearable wireless controller of claim 10, wherein the sleeve is tapered towards the first end thereof.

12) The wearable wireless controller of claim 10, wherein the first end of the sleeve is closed.

13) A wearable wireless controller, comprising:
a sleeve having an open first end and an open second end, wherein the sleeve is tapered towards the first end and configured to be worn on a finger of a hand;
one or more controls disposed on an exterior of the sleeve and configured to control an audio playing device;
an audio playing device;
a wireless transmitter operably connected to the one or more controls and configured to wirelessly connect the one or more controls to the audio playing device.
